(19) United States
(12) Patent Application Publication
(10) Pub. No.: US 2014/0232514 A1
(43) Pub. Date: Aug. 21, 2014

(54) THERMISTOR AND METHOD FOR MANUFACTURING THE SAME

(71) Applicant: Murata Manufacturing Co., Ltd., Nagaokakyo-shi (JP)

(72) Inventors: Tadamasa Miura, Nagaokakyo-shi (JP); Michiru Mikami, Nagaokakyo-shi (JP)

(73) Assignee: MURATA MANUFACTURING CO., LTD., Nagaokakyo-shi (JP)

(21) Appl. No.: 14/266,904

(22) Filed: May 1, 2014

Related U.S. Application Data
(63) Continuation of application No. PCT/JP2012/076409, filed on Oct. 12, 2012.

(30) Foreign Application Priority Data
Nov. 15, 2011 (JP) 2011-249220

(51) Int. Cl. H01C 7/00; H01C 17/30

(52) U.S. Cl. CPC H01C 7/008; H01C 17/30
USPC 338/22 R; 156/89.17

(57) ABSTRACT

A thermistor that includes a metal substrate layer, a thermistor thin film formed on the metal substrate layer, and electrode films formed on the thermistor thin film. The metal substrate layer and the electrode films contain a Ag—Pd alloy, and the content of Pd of the Ag—Pd alloy is 10 percent by weight or more.

### CROSS REFERENCE TO RELATED APPLICATIONS

The present application is a continuation of International application No. PCT/JP2012/076409, filed Oct. 12, 2012, which claims priority to Japanese Patent Application No. 2011-249220, filed Nov. 15, 2011, the entire contents of each of which are incorporated herein by reference.

### FIELD OF THE INVENTION

The present invention relates to a thermistor including a thermistor thin film formed on a metal substrate layer and an electrode film formed on the thermistor thin film, and more particularly relates to a thermistor in which an adhesion strength between a metal substrate layer and a thermistor thin film and an adhesion strength between the thermistor thin film and an electrode film are not likely to be decreased and in which the resistance is not likely to be changed.

### BACKGROUND OF THE INVENTION

Heretofore, as an NTC thermistor or a PTC thermistor, which is used as a temperature sensor in a protective circuit, a thermistor disclosed in Patent Document 1 (Japanese Unexamined Patent Application Publication No. 61-245502) has been known. This thermistor has the structure in which a temperature sensitive resistive film (thermistor thin film) is formed, for example, by a sputtering method on a flat metal substrate also functioning as an electrode, and on this temperature sensitive resistive film, an electrode film is formed, for example, by a thick film forming method or a vacuum deposition method. In addition, although not being disclosed in Patent Document 1, the temperature sensitive resistive film formed by a sputtering method is generally processed by a heat treatment after the formation thereof.

According to the thermistor disclosed in this Patent Document 1, for example, Ti, Ta, Mo, W, Pt, an Fe—Cr alloy, or an Fe—Ni—Co alloy is used for the flat metal substrate also functioning as an electrode; for example, a composite oxide containing Fe, Ni, Co, Mn, or the like, SiC, or Ge is used for the temperature sensitive resistive film; and for example, a Au—Pt alloy, a Ag—Pd alloy, Pt, Pd, Au, a Cr—Au alloy, a Cr—Cu alloy, or Al is used for the electrode film.

In addition, as another conventional NTC or PTC thermistor, a thermistor disclosed in Patent Document 2 (WO2011/024724) has also been known. This thermistor has the structure in which a thermistor thin film is formed on a metal substrate layer, and a pair of electrode films is formed on this thermistor thin film. The thermistor described above is manufactured as described below. For example, an electrically conductive paste to be formed into the metal substrate layer is applied to one primary surface of a ceramic green sheet, and an electrically conductive paste to be formed into the electrode films is also applied on the other primary surface of the ceramic green sheet, so that a ceramic green sheet to be formed into the thermistor thin film is prepared. Subsequently, this ceramic green sheet is cut into at least a chip having a predetermined dimension, and the chip thus obtained is then fired.

According to the thermistor disclosed in this Patent Document 2, an element, such as a noble metal or a base metal, or an alloy containing the element mentioned above, such as a Ag—Pd alloy, may be used for the metal substrate layer and the electrode film, and for the thermistor thin film layer, various ceramic materials containing appropriate amounts of Mn, Ni, Fe, Ti, Co, Al, Zn, and/or the like may be used in arbitrary combination.

As described above, according to the thermistor disclosed in Patent Document 1, a Ag—Pd alloy may be used for the electrode film in some cases, and according to the thermistor disclosed in Patent Document 2, a Ag—Pd alloy may be used for the metal substrate layer and the electrode film in some cases. The reasons a Ag—Pd alloy is selected among various materials are believed as follows.

(1) Like Ag or Au, a Ag—Pd alloy may also form an ohmic contact with a Mn-based spinel structural material.

(2) Although Ag migration may occur in some cases during the use of a thermistor using Ag, when a Ag—Pd alloy is used, Ag migration can be suppressed from being generated.

(3) Since having a higher melting point than that of Ag, when a Ag—Pd alloy is used instead of using Ag, a thermistor thin film can be fired at a higher temperature, and hence the characteristics of the thermistor can be improved.

(4) As compared to Au, a Ag—Pd alloy can be commercially available at a lower price.

For the reasons as described above, it is believed that a Ag—Pd alloy is used for the metal substrate layer and the electrode film of the thermistor.

Patent Document 1: Japanese Unexamined Patent Application Publication No. 61-245502

Patent Document 2: WO2011/024724

### SUMMARY OF THE INVENTION

As described above, a Ag—Pd alloy is a superior material for the metal substrate layer and the electrode film of the thermistor. However, when a conventional thermistor in which without any consideration of the content of Pd, a Ag—Pd alloy is used for a metal substrate layer and/or an electrode film is subjected to a high-temperature and high-humidity environment, a problem may arise in that the resistance of the thermistor is remarkably changed.

In addition, the applicant of the present application carried out various experiments and analyses to understand the reasons the resistance is remarkably changed when a thermistor is subjected to a high-temperature and high-humidity environment, and it was found that because of moisture which enters the inside of the thermistor, or in the case in which a plating treatment is performed on the thermistor, because of corrosive components, such as chlorine, which are contained in a plating solution and which enter the inside of the thermistor, connection of the thermistor thin film to the metal substrate layer and/or the electrode film is disconnected, and the resistance is remarkably changed. In more particular, it was also found that when a Ag content of a Ag—Pd alloy is high, although an initial adhesion strength between the thermistor thin film and the metal substrate layer and/or the electrode film is high, by a plating treatment, a humidity resistant test, and the like, the adhesion strength is remarkably decreased, and the resistance is remarkably changed.

In addition, the problem of the change in resistance caused by the decrease in adhesion strength is more serious for a thermistor in which a thermistor thin film is formed on a metal substrate layer, and an electrode film is formed on the thermistor thin film than the problem for a laminate type thermistor in which a plurality of thermistor thin film layers and a plurality of internal electrode layers are alternately laminated to each other.

That is, in the laminate type thermistor, the size of the internal electrode layer to be laminated is one size smaller than the size of the thermistor thin film layer to be laminated. As a result, when a thermistor thin film layer, an internal electrode layer, and another thermistor thin film layer are laminated in this order, the former thermistor thin film layer and the latter thermistor thin film layer directly come into contact with each other along the periphery of the internal electrode layer provided therebetween. The adhesion strength at this portion is very high since the both of them are formed of the same thermistor ceramic material. Hence, in the laminate type thermistor, even if a corrosive component enters between the thermistor thin film layer and the internal electrode layer, and in addition, even if the thermistor is subjected to a high-temperature and high-humidity environment, since the adhesion strength is reinforced by the two adjacent thermistor thin film layers which are adhered to each other with a high adhesion strength along the periphery of the internal electrode layer, the connection between the thermistor thin film layer and the internal electrode layer is not likely to be disconnected, and the resistance of the thermistor is not likely to be changed.

On the other hand, in the case of a thermistor in which a thermistor thin film is formed on a metal substrate layer, and on the thermistor thin film, an electrode film is formed, the connection of the thermistor thin film to the metal substrate layer and/or the electrode film is maintained only by the adhesion strength at the connection interface therebetween since the adhesion strength is not reinforced at all. Hence, in the thermistor in which a thermistor thin film is formed on a metal substrate layer, and on the thermistor thin film, an electrode film is formed, when a corrosive component enters between the thermistor thin film layer and the metal substrate layer and/or between the thermistor thin film layer and the electrode film, and in addition, when the thermistor is subjected to a high-temperature and high-humidity environment, the connection between the thermistor thin film layer and the metal substrate layer and/or the connection between the thermistor thin film layer and the electrode film is liable to be disconnected, and the resistance of the thermistor is liable to be changed, so that the problem becomes more serious.

The present invention was made to overcome the problem of the above conventional thermistor. The problem of the related thermistor is that when the thermistor is subjected to a high-temperature and high-humidity environment, the connection between the thermistor thin film layer and the metal substrate layer and/or the connection between the thermistor thin film layer and the electrode film is disconnected, and the resistance is remarkably changed.

As a method for overcoming the problem, a thermistor of the present invention is configured to include a metal substrate layer, a thermistor thin film formed on the metal substrate layer, and an electrode film formed on the thermistor thin film, the metal substrate layer and the electrode film are configured to contain a Ag—Pd alloy, and the content of Pd in the Ag—Pd alloy is set to 10 percent by weight or more.

In addition, the content of Pd in the Ag—Pd alloy is preferably 20 percent by weight or more. The reason for this is that even if the thermistor is subjected to a high-temperature and high-humidity environment, the change in resistance can be further reduced.

In addition, the content of Pd in the Ag—Pd alloy is more preferably 30 percent by weight or more. The reason for this is that even if the thermistor is subjected to a high-temperature and high-humidity environment, the change in resistance can be further reduced.

In addition, the electrode film may be configured to be a pair of split electrode films. In this case, a thermistor can be formed such that one electrode film, the thermistor thin film, and the metal substrate layer form a first thermistor portion, the other electrode film, the thermistor thin film, and the metal substrate layer form a second thermistor portion, and the first thermistor portion and the second thermistor portion are connected in series.

Since the thermistor of the present invention is configured to have the structure as described above, even if the thermistor is subjected to a high-temperature and high-humidity environment, the connection strength between the thermistor thin film layer and the metal substrate layer and/or the connection strength between the thermistor thin film layer and the electrode film is not likely to be decreased, and hence, the resistance of the thermistor is not likely to be changed.

Incidentally, the reason even if the thermistor of the present invention is subjected to a high-temperature and high-humidity environment, the connection strength between the thermistor thin film layer and the metal substrate layer and/or the connection strength between the thermistor thin film layer and the electrode film is not likely to be decreased is believed as follows.

In a Ag—Pd alloy at a temperature of approximately 600 to 800° C., Pd is oxidized to PdO. It is believed that at this stage, a reaction occurs with a thermistor material to form a compound, and as a result, the adhesiveness is increased.

On the other hand, from a thermodynamic point of view, Ag is intrinsically stable in the form of an oxide Ag₂O at a temperature of 200° C. or less, and Ag, which is a metal element, is stable at a temperature of more than 200° C. However, at a temperature of 200° C. or less at which Ag is oxidized, since thermal energy necessary for reaction is low, the rate of an oxidation reaction, 2Ag+½O₂→Ag₂O, is extremely low, and at room temperature, Ag is apparently maintained as if it is not changed. In this case, it is believed that although Ag is connected to an element of the thermistor material via oxygen, since Ag itself is not oxidized, the bond between Ag and oxygen may be easily dissociated.

According to the thermistor of the present invention, it is believed that since the content of Pd in the Ag—Pd alloy is set to 10 percent by weight or more so as to increase the ratio of Pd having a high adhesion strength, the connection between the thermistor thin film layer and the metal substrate layer and/or the connection between the thermistor thin film layer and the electrode film is not likely to be disconnected.

### BRIEF DESCRIPTION OF THE DRAWINGS

FIGS. 1(A) and (B) each show an NTC thermistor 100 according to an embodiment of the present invention, FIG. 1(A) is a plan view, and FIG. 1(B) is a cross-sectional view taken along the X-X′ portion of FIG. 1(A).

FIG. 2 is an equivalent circuit diagram of the NTC thermistor 100 according to the embodiment of the present invention.

FIGS. 3(A) to (C) are cross-sectional views each showing a step used in one example of a method for manufacturing the NTC thermistor 100 according to the embodiment of the present invention.

FIGS. 4(D) to (F) are cross-sectional views each showing a step used in one example of the method for manufacturing the NTC thermistor 100 according the embodiment of the present invention, the steps being performed following the step shown in FIG. 3(C).

FIG. 5(A) is a perspective view showing a test piece 20 to be used in Experimental Example 2, and FIG. 5(B) is a front view showing Experimental Example 2.

### DETAILED DESCRIPTION OF THE PREFERRED EMBODIMENTS

Hereinafter, with reference to the drawings, embodiments of the present invention will be described.

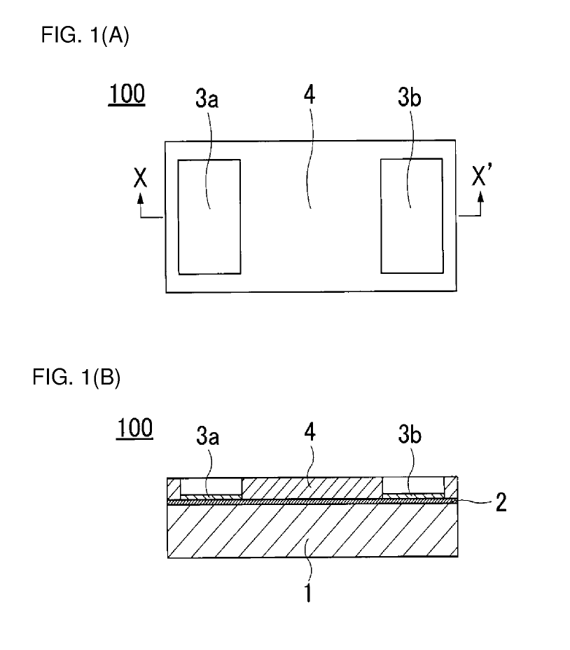

FIGS. 1(A) and (B) each show an NTC thermistor 100 according to an embodiment of the present invention.

The NTC thermistor 100 includes a metal substrate layer 1. The metal substrate layer 1 contains a Ag—Pd alloy as a primary component and other components, such as a glass component. In the Ag—Pd alloy contained in the metal substrate layer 1, the content of Pd is controlled to 10 percent by weight or more. The metal substrate layer 1 is formed, for example, to have a thickness of 30 μm.

On the metal substrate layer 1, there is provided a thermistor thin film 2 formed of a ceramic containing at least two selected from the group consisting of Mn, Ni, Fe, Ti, Co, Al, and Zn. The thermistor thin film 2 is formed, for example, to have a thickness of 3 μm.

On the thermistor thin film 2, a pair of electrode films 3a and 3b is formed. The electrode films 3a and 3b each contain a Ag—Pd alloy as a primary component and other components, such as a glass component. In the Ag—Pd alloy contained in the electrode films 3a and 3b, the content of Pd is controlled to 10 percent by weight or more. The electrode films 3a and 3b are each formed, for example, to have a thickness of 3 μm.

On a region of the thermistor thin film 2 on which the electrode films 3a and 3b are not formed, a protective film 4 is formed. The protective film 4 is formed, for example, of a ceramic containing as a primary component, Fe₂O₃ having insulating properties and excellent plating resistance. The protective film 4 is formed, for example, to have a thickness of 10 μm.

In addition, although being not shown in FIGS. 1(A) and (B), a Ni plating film and a Sn plating film are sequentially formed in this order on the electrode films 3a and 3b exposed through a protective layer 4. The thickness of the Ni plating film and that of the Sn plating film are, for example, 2 μm and 3 μm, respectively. In addition, when the plating films are formed, the protective layer 4 having an excellent plating resistance protects the thermistor thin film 2.

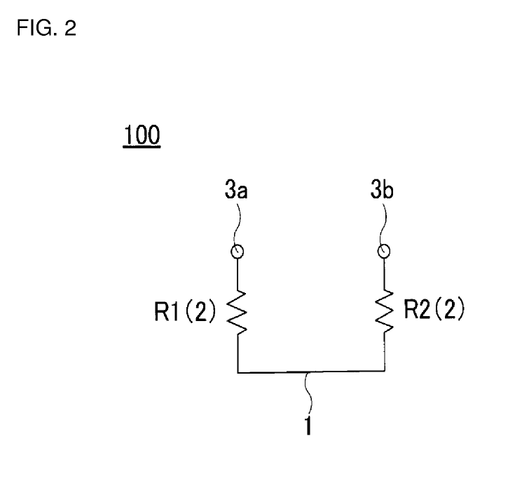

The NTC thermistor 100 according to the embodiment of the present invention having the above-described structure has an equivalent circuit shown in FIG. 2. That is, the NTC thermistor 100 has an equivalent circuit in which the electrode film 3a, the thermistor thin film 2, and the metal substrate layer 1 form a thermistor portion R1, the electrode film 3b, the thermistor thin film 2, and the metal substrate layer 1 form a thermistor portion R2, and the thermistor portion R1 and the thermistor portion R2 are connected in series.

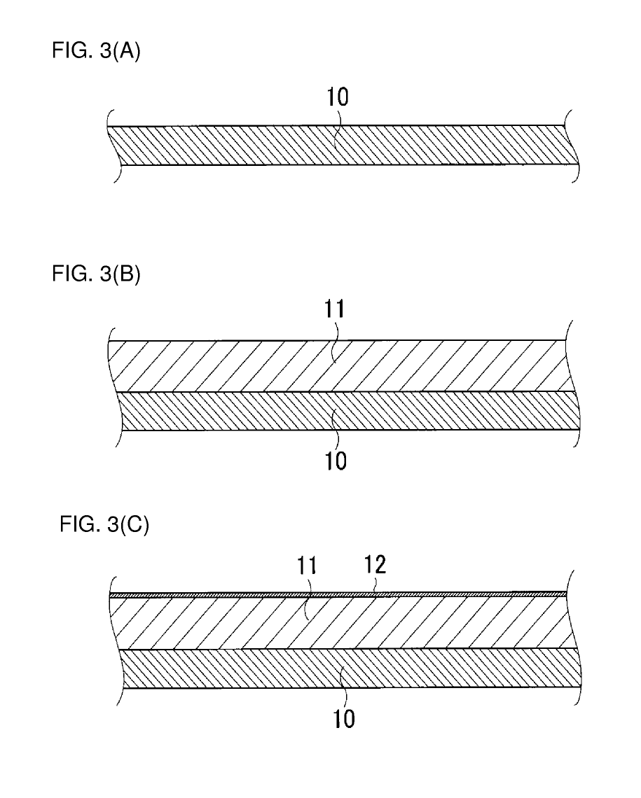

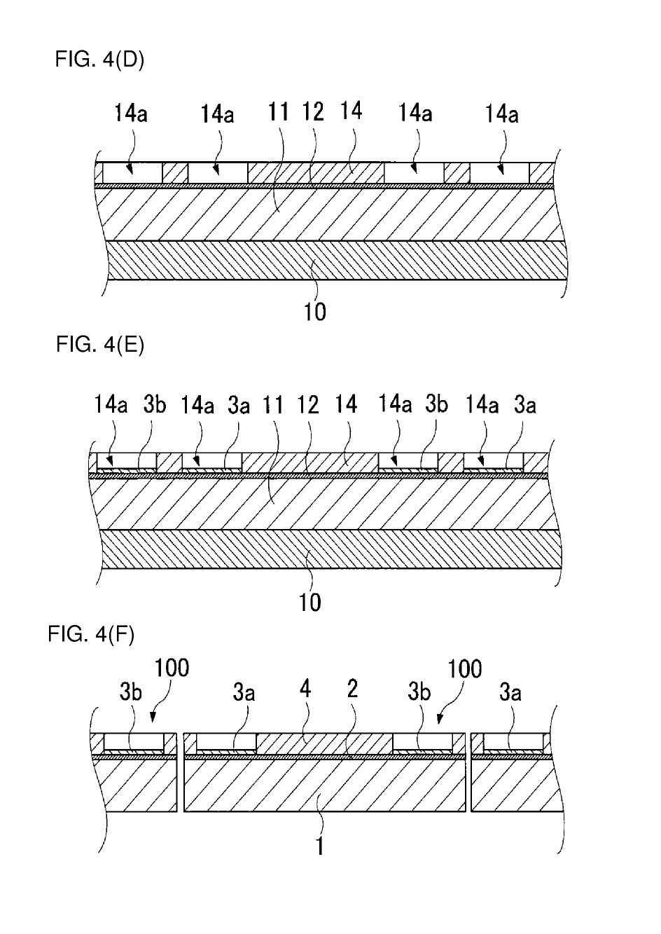

The NTC thermistor 100 according to the embodiment of the present invention having the above-described structure is formed, for example, by a method shown in FIGS. 3(A) to 4(F).

First, an electrically conductive paste forming the metal substrate layer 1 and the electrode films 3a and 3b is formed in advance. More specifically, for example, after 90 percent by weight of Ag and 10 percent by weight of Pd are weighed, and 2 percent by weight of an organic solvent and an organic binder is added on the weight ratio of a resin solid component to the metal powders, a dispersing and mixing treatment is performed with a three-roller mill, so that an electrically conductive paste forming the metal substrate layer 1 and the electrode films 3a and 3b is obtained.

In addition, a thermistor thin-film ceramic paste forming the thermistor thin film 2 is formed in advance. More specifically, for example, after oxides of Mn, Ni, Fe, and Ti are weighed to have a predetermined composition (for example, to have a resistivity of 10⁴ Ωcm) and are then charged into a ball mill, wet pulverization is performed using pulverizing media formed of zirconia or the like, and calcination is then performed in accordance with a predetermined profile (such as at 800° C. for 2 hours), so that a ceramic powder is obtained. Next, after an organic binder is added to this ceramic powder, a wet mixing treatment is performed, so that a ceramic paste forming the thermistor thin film 2 is obtained.

In addition, in accordance with the method for forming a thermistor thin-film ceramic paste described above, an insulating ceramic paste forming the protective layer 4 is formed.

Next, as shown in FIG. 3(A), a carrier film 10 formed from a PET or the like is prepared.

Next, as shown in FIG. 3(B), the electrically conductive paste formed in advance is printed on the carrier film 10 by a screen printing method, so that a metal substrate layer 11 is formed. Incidentally, this manufacturing method is a method to simultaneously manufacture many NTC thermistors 100, and the metal substrate layer 11 is a collective of the metal substrate layers 1 of the NTC thermistors 100. The metal substrate layer 11 is formed, for example, to have a thickness of 30 μm after firing thereof.

Next, as shown in FIG. 3(C), the thermistor thin-film ceramic paste formed in advance is printed on the metal substrate layer 11 by a screen printing method, so that a thermistor thin film 12 is formed. Incidentally, the thermistor thin film 12 is a collective of the thermistor thin films 2 of the NTC thermistors 100. The thermistor thin film 12 is formed, for example, to have a thickness of 3 μm after firing thereof.

Next, as shown in FIG. 4(D), the insulating ceramic paste formed in advance is printed on the thermistor thin film 12 by a screen printing method, so that a protective layer 14 is formed. In the protective layer 14, a plurality of openings 14a are formed in predetermined regions. Incidentally, the protective layer 14 is a collective of the protective layers 4 of the NTC thermistors 100. The protective layer 14 is formed, for example, to have a thickness of 10 μm after firing thereof.

Next, as shown in FIG. 4(E), the electrically conductive paste formed in advance is printed by a screen printing method on the thermistor thin film 12 exposed through the openings 14a of the protective layer 14, so that the electrode films 3a and 3b are formed. The electrode films 3a and 3b are formed, for example, to have a thickness of 3 μm after firing thereof.

Next, as shown in FIG. 4(F), a laminate formed of the metal substrate layer 11, a thermistor thin film layer 12, electrode layers 3a and 3b, and the protective layer 14 is peeled away from the carrier film 10 and is then cut into individual green NTC thermistors 100.

Next, although not shown in the drawings, the green NTC thermistor 100 obtained by cutting is fired, for example, in accordance with a profile at 950° C. for 2 hours.

Finally, although not shown in the drawings, a Ni plating film and a Sn plating film are sequentially formed in this order by a wet plating method on the electrode films 3a and 3b of the fired NTC thermistor 100.

Heretofore, the structure of the NTC thermistor 100 according to the embodiment of the present invention and an exemplary manufacturing method thereof have been described. However, the present invention is not limited to the content described above and may be variously changed and modified without departing from the scope of the present invention.

For example, in the above embodiment, although the NTC thermistor has been disclosed as the thermistor, the thermistor is not limited to an NTC thermistor, and the present invention may also be applied to a PTC thermistor.

In addition, in the above embodiment, although the pair of the electrode films 3a and 3b is formed on the thermistor thin film 2 formed on the metal substrate layer 1, instead of forming the pair of the electrode films 3a and 3b, one electrode film may be formed. In this case, the metal substrate layer 1 may also be used as another electrode film.

In addition, in the manufacturing method described above, in order to form the electrically conductive paste, although a Ag—Pd alloy powder is formed in advance, instead of using the method described above, an electrically conductive paste may also be formed in such a way that after a Ag powder and a Pd powder are mixed together, an organic vehicle is added to the mixture thus formed.

### EXAMPLES

In order to confirm the advantages of the present invention, the following experiments were carried out.

### Experimental Example 1

In this experiment, first, 7 types of electrically conductive pastes of Samples 1 to 7 were formed.

The electrically conductive paste of Sample 1 contained Ag as an electrically conductive powder.

The electrically conductive pastes of Samples 2 to 6 each contained a Ag—Pd alloy as an electrically conductive powder, and the contents of Pd of Samples 2 to 6 were 10, 20, 30, 50, and 70 percent by weight, respectively. In addition, the content of Ag was obtained by subtracting the content of Pd from 100 (percent by weight).

The electrically conductive paste of Sample 7 contained Pd as an electrically conductive powder.

Next, by using the electrically conductive pastes of Samples 1 to 7, 1,000 NTC thermistors of each of Samples 1 to 7 were manufactured by a method similar to that of the above embodiment of the present invention. In addition, the NTC thermistors of Samples 2 to 6 were in the range of the present invention, and the NTC thermistors of Samples 1 and 7 were out of the range of the present invention (incidentally, for the convenience, the sample No. was used to correlate between the electrically conductive paste and the NTC thermistor in such a way that the NTC thermistor using “the electrically conductive paste of Sample 1” was represented by “the NTC thermistor of Sample 1”).

Next, after the NTC thermistor of each Sample was mounted on a substrate by Sn-3.0Ag-0.5Cu solder and was then left under a high-temperature and high-humidity environment at a temperature of 60° C. and a humidity of 95% for 300 hours, the rate of change in resistance was measured before and after the thermistor was left (n=1,000 thermistors). As the rate of change in resistance, the rate of elements which showed a resistance change of 10% or more was used.

In Table 1, the measurement results are shown.

TABLE 1

| | Content of Pd of | Rate of Elements having |
|---|---|---|
| | Electrically | Resistance Change of 10% |
| | Conductive Material in | or more by Shelf Test at |
| | Electrically | 60° C. and 95% RH for 300 |
| Sample No. | Conductive Paste (Wt %) | Hours (%) |
| *1 | 0 | 15.5 |
| 2 | 10 | 2.8 |
| 3 | 20 | 0.5 |
| 4 | 30 | 0 |
| 5 | 50 | 0 |
| 6 | 70 | 0 |
| *7 | 100 | 0 |

(Sample with * is out of the range of the present invention.)

In the NTC thermistor of Sample 1 which is out of the range of the present invention, the rate of elements having a resistance change of 10% or more is 15.5%, and this value indicates that this NTC thermistor cannot be practically used.

On the other hand, in the NTC thermistor of Sample 2 using an electrically conductive paste which has a content of Pd of 10 percent by weight and which is in the range of the present invention, the rate of elements having a resistance change of 10% or more is 2.8% and is significantly improved as compared to that of Sample 1.

In addition, in the NTC thermistor of Sample 3 using an electrically conductive paste which has a content of Pd of 20 percent by weight and which is in the range of the present invention, the rate of elements having a resistance change of 10% or more is 0.5%, and this value indicates that this NTC thermistor can be practically used.

Furthermore, in the NTC thermistors of Samples 4 to 6 using electrically conductive pastes which have a content of Pd of 30 to 70 percent by weight and which are in the range of the present invention, the rate of elements having a resistance change of 10% or more is 0%, and this value is a preferable value.

On the other hand, in the NTC thermistor of Sample 7 using an electrically conductive paste which has a content of Pd of 100 percent by weight and which is out of the range of the present invention, the rate of elements having a resistance change of 10% or more is also 0%, and this value is a preferable value. However, since Pd is significantly expensive as compared to Ag, and in order to reduce the rate of change in resistance, since a content of Pd of 20 percent by weight or more may be good enough, the NTC thermistor of Sample 7 having a content of Pd of 100 percent by weight is regarded as out of the range of the present invention.

As described above, according to the present invention, the change in resistance of the thermistor under a high-temperature and high-humidity environment can be reduced.

### Experimental Example 2

In this experiment, the adhesion strength of the electrically conductive paste of each of Samples 1 to 7 formed in Experimental Example 1 to a thermistor ceramic was investigated.

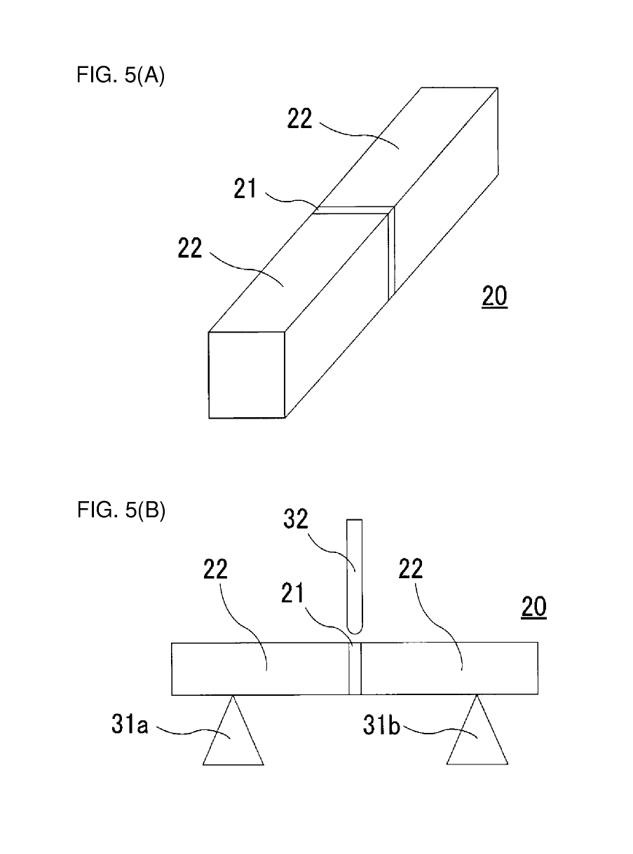

In this experiment, first, a test piece 20 shown in FIG. 5(A) was formed.

More specifically, first, a ceramic powder forming a thermistor thin film was prepared to manufacture the NTC thermistor of the above embodiment, and a ceramic slurry was formed using the ceramic powder thus prepared. In addition, by the use of this ceramic slurry, a ceramic green sheet was formed by a doctor blade method and was then further cut into many ceramic green sheet pieces each having a predetermined dimension.

Subsequently, 14 ceramic green sheet pieces thus obtained and the electrically conductive pastes of Samples 1 to 7 formed in Experimental Example 1 were prepared, and each electrically conductive paste was printed on the surfaces of two ceramic green sheet pieces by a screen printing method. That is, two ceramic green sheet pieces on which the electrically conductive paste of each of Samples 1 to 7 was printed, that is, totally 14 ceramic green sheet pieces, were obtained.

Next, a plurality of ceramic green sheet pieces on which the conductive paste was not printed were laminated on each of the top and the bottom sides of each of the 14 ceramic green sheet pieces and were then pressure-bonded, so that 14 laminates were obtained.

Subsequently, those 14 laminates were fired in accordance with a profile at 950° C. for 2 hours, and the fired laminates were processed by dicing. As a result, two test pieces 20 of each of Samples 1 to 7, that is, totally 14 test pieces, were obtained, the test pieces each shown in FIG. 5(A) having a square columnar shape of 1.0×1.0×5 mm and having the structure in which a metal layer 21 was arranged at the center and ceramic layers 22 were arranged at both sides of the metal layer 21 (incidentally, for the convenience, the sample No. was used to correlate between the electrically conductive paste and the test piece in such a way that the test piece using “the electrically conductive paste of Sample 1” was represented by “the test piece of Sample 1”).

Next, an initial adhesion strength between the metal layer 21 and the ceramic layer 22 of the test piece 20 was investigated.

More specifically, after one test piece 20 of each of Samples 1 to 7 was prepared, that is, after totally 7 test pieces were prepared, as shown in FIG. 5(B), a flexural test using an autograph was sequentially performed on the test pieces thus prepared in such a way that the test piece was placed on a pair of supporting jigs 31a and 31b, and a metal layer 21 portion was pressurized by a pressure application member 32 from the above. A strength at which the metal layer 21 and the ceramic layer 22 were separated from each other was measured and was regarded as the adhesion strength between the metal layer 21 and the ceramic layer 22.

In Table 2, the measurement results are shown (in the second column from the right side of Table 2).

TABLE 2

| | Content of Pd of | | Adhesion strength |
|---|---|---|---|
| | electrically conductive | Initial | after shelf test |
| | material in | adhesion | at 60° C. and 95% RH |
| Sample | electrically conductive | strength | for 300 hours |
| NO. | paste (wt %) | (MPa) | (MPa) |
| *1 | 0 | 171 | 28.5 |
| 2 | 10 | 162 | 35.3 |
| 3 | 20 | 154 | 42.6 |
| 4 | 30 | 149 | 55.4 |
| 5 | 50 | 131 | 61.8 |
| 6 | 70 | 127 | 77.2 |
| *7 | 100 | 103 | 92.1 |

(Sample No. provided with * indicates that an electrically conductive paste out of the range of the thermistor of the present invention is used.)

Next, after being dipped in a Ni plating liquid for one hour, the test pieces 20 of Samples 1 to 7 were left for 300 hours under a high-temperature and high-humidity environment at 60° C. and a relative humidity of 95%, and the adhesion strength between the metal layer 21 and the ceramic layer 22 was then investigated. More specifically, after one test piece 20 of each of Samples 1 to 7 was prepared, that is, after totally 7 test pieces were prepared, the above plating treatment and the shelf test under a high-temperature and high-humidity environment were performed on the test pieces, and the adhesion strength was measured by the same method as described above.

In Table 2, the measurement results are shown (in the column located at the most right side of Table 2).

As apparent from the measurement results, the initial adhesion strength is increased as the content of Pd is decreased. However, after the test pieces are dipped in the plating solution and are subjected to the shelf test under a high-temperature and high-humidity environment, the adhesion strength is decreased as the content of Pd is decreased. That is, it is found that when the content of Pd is low, by the plating treatment and/or the shelf test under a high-temperature and high-humidity environment, the adhesion strength is remarkably decreased.

More specifically, in the case of the test piece of Sample 1 using the electrically conductive paste which contained Ag but contained no Pd and which is not applied to the thermistor of the present invention, the adhesion strength after the plating treatment and the shelf test under a high-temperature and high-humidity environment is remarkably decreased, and hence, a problem may arise in practice.

On the other hand, in the case of the test pieces of Samples 2 to 6, each using the electrically conductive paste which contained 10 to 70 percent by weight of Pd and which can be applied to the thermistor of the present invention, the adhesion strength after the plating treatment and the shelf test under a high-temperature and high-humidity environment is preferably not so much decreased.

On the other hand, in the case of the test piece of Sample 7 using the electrically conductive paste which contained 100 percent by weight of Pd and which is not applied to the thermistor of the present invention, since the decrease in adhesion strength after the plating treatment and the shelf test under a high-temperature and high-humidity environment is small, a problem may not arise; however, there may be other problems in that the initial adhesion strength is relatively low and a large amount of Pd, which is significantly expensive as compared to Ag, must be used.

As has thus been described, it is found that even if the thermistor of the present invention is exposed to a high-temperature and high-humidity environment, the adhesion strength between the metal substrate layer and the thermistor thin film and the adhesion strength between the thermistor thin film and the electrode film are not likely to be decreased.

### REFERENCE SIGNS LIST

1, 11 metal substrate layer
2, 12 thermistor thin film
3a, 3b electrode film
4, 14 protective layer
10: carrier film
100: NTC thermistor

1. A thermistor comprising:
a metal substrate layer;
a thermistor film on the metal substrate layer; and
an electrode film on the thermistor film,
wherein the metal substrate layer and the electrode film contain a Ag—Pd alloy, and
a content of Pd of the Ag—Pd alloy is 10 percent by weight or more.

2. The thermistor according to claim 1, wherein the content of Pd of the Ag—Pd alloy is 20 percent by weight or more.

3. The thermistor according to claim 1, wherein the content of Pd of the Ag—Pd alloy is 30 percent by weight or more.

4. The thermistor according to claim 1, wherein the thermistor film includes a ceramic containing at least two selected from Mn, Ni, Fe, Ti, Co, Al, and Zn.

5. The thermistor according to claim 1, wherein the electrode film includes a pair of split electrode films.

6. The thermistor according to claim 5, further comprising a protective film on a region of the thermistor film on which the pair of split electrode films are not located.

7. The thermistor according to claim 6, wherein the protective film includes a ceramic containing, as a primary component, Fe₂O₃.

8. The thermistor according to claim 1, further comprising a protective film on a region of the thermistor film on which the electrode film is not located.

9. The thermistor according to claim 8, wherein the protective film includes a ceramic containing, as a primary component, Fe₂O₃.

10. The thermistor according to claim 1, further comprising a plating film on the electrode film.

11. The thermistor according to claim 10,
wherein the plating film includes two layers, and
the two layers are a Ni plating film and a Sn plating film.

12. The thermistor according to claim 11, wherein the Ni plating film is between the Sn plating film and the electrode film.

13. A method for manufacturing a thermistor, the method comprising:
preparing a carrier film;
applying a first electrically conductive paste containing a Ag—Pd alloy for a metal substrate layer on the carrier film;
applying a ceramic paste for a thermistor thin film on the first electrically conductive paste;
applying a second electrically conductive paste containing a Ag—Pd alloy for an electrode film on the ceramic paste;
peeling a laminate from the carrier film, the laminate being formed of the first electrically conductive paste containing a Ag—Pd alloy, the ceramic paste, and the second electrically conductive paste containing a Ag—Pd alloy; and
firing the laminate in accordance with a predetermined profile so as to obtain a thermistor element in which the thermistor film is on the metal substrate layer and the electrode film is on the thermistor film,
wherein a content of Pd of the Ag—Pd alloy is 10 percent by weight or more.

14. The method for manufacturing a thermistor according to claim 13, wherein the content of Pd of the Ag—Pd alloy is 20 percent by weight or more.

15. The method for manufacturing a thermistor according to claim 13, wherein the content of Pd of the Ag—Pd alloy is 30 percent by weight or more.

16. The method for manufacturing a thermistor according to claim 13, further comprising:
before the step of applying the second electrically conductive paste, applying an insulating ceramic paste for a protective film on the ceramic paste, the insulating ceramic paste having a plurality of openings therein; and
applying the second electrically conductive paste in the openings of the insulating ceramic paste.

17. The method for manufacturing a thermistor according to claim 13, wherein the predetermined profile is 950° C. for 2 hours.
